(19) United States
(12) Patent Application Publication
(10) Pub. No.: US 2020/0160142 A1
(43) Pub. Date: May 21, 2020

(54) METHOD, SYSTEM, AND APPARATUS FOR RFID LABEL FORMATION AND PLACEMENT

(71) Applicant: AVERY DENNISON RETAIL INFORMATION SERVICES LLC

(72) Inventor: Mark W. ROTH, North Miami, FL (US)

(21) Appl. No.: 16/686,735

(22) Filed: Nov. 18, 2019

Related U.S. Application Data
(60) Provisional application No. 62/768,336, filed on Nov. 16, 2018.

(51) Int. Cl. G06K 19/077; G06K 7/10

(52) U.S. Cl. CPC G06K 19/07786; G06K 7/10366; G06K 19/0775; G06K 7/10346; G06K 7/10178

(57) ABSTRACT

A method, system, and apparatus for forming and applying an RFID label may be shown and described herein. Exemplary embodiments can include a new type of RFID inlay that has a multi-element antenna design, allowing for an RFID label thus equipped to be coupled to a carton, for example, around an edge or a corner. Thus, even if part of the RFID label is blocked or obscured, for example by neighboring cartons, the label can still be read as desired.

### CROSS REFERENCE TO RELATED APPLICATION(S)

The present application claims priority from U.S. Provisional Application No. 62/768,336 filed Nov. 16, 2018, which is incorporated by herein by reference in its entirety.

### FIELD OF THE INVENTION

The present invention relates generally to radio frequency identification (RFID) labels for use on any sort of packaging such as, but not limited to, product packaging, cartons, and other product containers. More particularly, the invention relates to a multi-portion label having an RFID inlay with a multi-element antenna.

### BACKGROUND

Radio frequency identification (RFID) labels are electronic devices that may be affixed to items whose presence is to be detected and/or monitored. The presence of an RFID label, and therefore the presence of the item or items to which the RFID label is affixed, may be checked and monitored by devices known as “readers” or “reader panels.” Readers typically transmit radio frequency signals to which the RFID labels respond. Each RFID label can store a unique identification number. The RFID labels respond to reader-transmitted signals by providing their identification number and additional information stored on the RFID label based on a reader command to enable the reader to determine an identification and characteristics of an item.

Current RFID labels are produced through the construction of an inlay, which includes a RFID chip connected to an antenna, applied to a substrate. The inlay is then inserted into a single label. These labels are then printed by either conventional printing processes, such as flexographic processes, and then variable information may be printed either with the static information or singularly. The RFID chips are then encoded in a printer which has a read/encoding device or separately by a reader/encoding device.

Another method of producing RFID labels includes producing a RFID device directly on a substrate. For example, a substrate is advanced and coated with an adhesive, and areas of the adhesive that are not needed in connection with adhering the antenna to the substrate are “deadened.” Alternatively, the adhesive can be pattern coated on to the substrate in the shape and configuration of an antenna. Next, a metal foil, such as aluminum, is applied over the adhesive and adhered only in those areas were an exposed and tacky adhesive remains. The metal foil can be further cut such as through a rotary die cutter and/or laser cutting device to further define the shape of the antenna. The remaining matrix of the metal foil is then removed, allowing only the final antenna shape to be adhered to the substrate, and a chip or strap is then applied over the contact ends of the antenna structure, such as with a dipole type antenna through the use of a conductive adhesive. A cover layer may be provided over the top of the chip or strap or alternatively over the entire area covered by the antenna.

As the use of RFID technology expands, the breadth and diversity of the product packaging material and the product content to which RFID technology is applied and for which it is utilized grows as well. The expansion and increased adoption of RFID technology, including tags, labels, and media, however, presents new challenges to such use as proper functionality of the RFID technology must be ensured.

For example, in the apparel industry, the product materials, namely fabrics, tend to be very conducive to allowing radio frequency (RF) signals to pass there through. Thus, the placement of RFID tags is not critical as the RF signals can communicate with an RF transceiver relatively freely.

However, when the same RFID technology is applied to different product segments, such as the food industry, new problems and challenges are seen regarding the effectiveness of the technology due to the contents of products housed within cartons and other product containers. For example, fluids such as water, juices, milk, cream, ice cream bases, coffee flavorings, and the like all tend to be found in liquid form. Such liquids, however, tend to mitigate or even prevent successful propagation of RF signals to and from RFID transponders. Likewise, proteins, such as beef, poultry, and seafood, which are each known to have a high water saturation content, and other products with high liquid content, may impede or prevent successful propagation of RF signals.

Traditional methods of improving RFID technology functionality with respect to such products and common RFID tags involves strict stacking, orientation, and organization of cartons of products and associated pallets. As seen in FIG. 1, all cartons must be arranged on a pallet so that the RFID tags are visible and not concealed or otherwise blocked by other cartons or pallets. In doing so, RF signals are allowed to freely propagate, and RFID tags can be scanned. However, if the two pallets of cartons are combined, as shown in FIG. 2, then the RFID tags on the rear cartons will be affected by the contents of the cartons and the ability of the RF signals on associated labels may be significantly impacted or rendered unworkable. In other words, if the RFID label ends up internal to the core of a pallet stack, the RFID inlay on an RFID tag or label can be blocked from receiving or transmitting signals to and from a transceiver. What is needed, therefore, is an RFID label that can receive and transmit signals to and from a transceiver regardless of the orientation of the carton or other container to which the RFID label is affixed.

### SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

To resolve the above issues, a method, system, and apparatus for forming and applying an RFID inlay for use in an RFID label may be shown and described herein. Exemplary embodiments can include a new type of RFID inlay that has a multi-element antenna design, allowing for an RFID label thus equipped to be coupled to a carton, for example, around an edge. Thus, even if part of the RFID label is blocked or obscured, the label can still be read as desired.

According to some embodiments, a RFID label comprises a substrate and an RFID inlay. In some embodiments, the substrate comprises a top face and a bottom face and defines a plurality of portions joined together at one or more fold lines. The substrate may be paper, cardstock, plastics such as PET, or other suitable materials. In some embodiments, the substrate can be printed on using methods such as thermal transfer, inkjet or laser printing. In some embodiments, the RFID inlay is disposed under the bottom face of the substrate and comprises a multi-element antenna and an RFID chip. In some embodiments, the RFID chip is located between and electrically connected to each element of the multi-element antenna.

In some embodiments, the plurality of portions of the RFID label comprises a first portion and a second portion. The first portion and the second portion may be joined together at a first fold line. In some embodiments, the plurality of portions of the RFID label further comprises a third portion. The first portion and the third portion may be joined together at a second fold line. Alternatively, the second portion and the third portion may be joined together at a second fold line.

In some embodiments, the multi-element antenna comprises a dual-element antenna comprising a first antenna element and a second antenna element. The first antenna element may be disposed adjacent to the bottom face of the substrate in the first portion, and the second antenna element may be disposed adjacent to the bottom face of the substrate in the second portion. In some embodiments, the RFID chip is configured to be activated by one or both of the first antenna element and the second antenna element. Each of the first antenna element and the second antenna element may be configured to send RF signals to and receive RF signals from an RFID reader.

According to other embodiments, the multi-element antenna comprises a three-element antenna comprising a first antenna element, a second antenna element, and a third antenna element. The first antenna element may be disposed adjacent to the bottom face of the substrate in the first portion, the second antenna element may be disposed adjacent to the bottom face of the substrate in the second portion, and the third antenna element may be disposed adjacent to the bottom face of the substrate in the third portion. In some embodiments, the RFID chip is configured to be activated by any one or more of the first antenna element, the second antenna element, and the third antenna element. Each of the first, second, and third antenna elements may be configured to send RF signals to and receive RF signals from an RFID reader.

In some embodiments, the one or more fold lines comprise one or more of a perforation, a score line, or a partial die-cut. In some embodiments, the RFID label comprises printed indicia on the top face of the substrate to indicate the location of the one or more fold lines. In some embodiments, the RFID label comprises an adhesive and a removable backing disposed adjacent to the adhesive.

According to some embodiments, a method of applying an RFID label to an item comprises securing a first portion of the RFID label having a first antenna element to a first area of the item and securing a second portion of the RFID label having a second antenna element to a second area of the item. In some embodiments, the first and second portions of the RFID label are joined together at a first fold line.

The first area of the item may be a first face of a carton, and the second area of the item may be a second face of the carton. In some embodiments, the first fold line is disposed along an edge that joins the first and second faces of the carton such that the first antenna element is secured to the first face of the carton and the second antenna element is secured to the second face of the carton. In some embodiments, the method comprises aligning indicia printed on a top face of the RFID label along the first fold line with the edge that joins the first and second faces of the carton.

In some embodiments, the method comprises securing a third portion of the RFID label having a third antenna element to a third area of the item. The third portion of the RFID label may be joined to one of the first or second portions of the RFID label at a second fold line. In some embodiments, the first area of the item is a first face of a carton, the second area of the item is a second face of the carton, and the third area of the item is a third face of the carton. The first and second fold lines may be disposed along different edges defined by the first, second, and third faces of the carton such that each of the first, second, and third antenna elements are secured to differing faces of the carton. For example, the first fold line may be disposed along the edge that joins the first and second faces of the carton, while the second fold line may be disposed along the edge that joins the first and third faces of the carton. In some embodiments, the RFID label is secured to the carton at or near a corner of the carton.

In some embodiments, the method comprises removing a removable backing from the RFID label to expose an adhesive disposed along at least a portion of a bottom surface of the RFID label. The first and second portions of the RFID label may be secured to the item by the adhesive. In embodiments in which an RFID label further comprises a third portion, the third portion may be secured to the item by the adhesive.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is a diagram of known carton stacking and pallet orientation, with traditional RFID tag placement;

FIG. 2 is diagram view of known carton stacking and pallet orientation, with traditional RFID tag placement;

FIG. 3A is an exemplary diagram showing a dual-element RFID device deployed on cartons and pallets;

FIG. 3B is an exemplary diagram showing a dual-element antenna design RFID label;

FIG. 4A is an exemplary diagram showing a three-element RFID device deployed on cartons and pallets; and

FIG. 4B is an exemplary diagram showing a three-element antenna design RFID label.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, a discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments”, or “invention” do not require that all embodiments of the invention include the discussed feature, advantage or mode of operation.

Further, as used herein, a variety of elements associated radio signals, radio frequency identification (RFID), and the like are described and shown. Such technology can often be embedded into media, commonly referred to as RFID labels, RFID tags, RFID media, and the like, and it should be appreciated that such terms can be used interchangeably as all incorporate the use of RFID embedded in the various media.

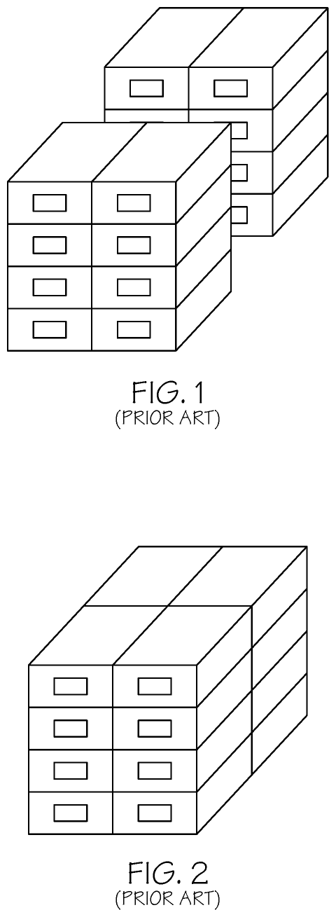

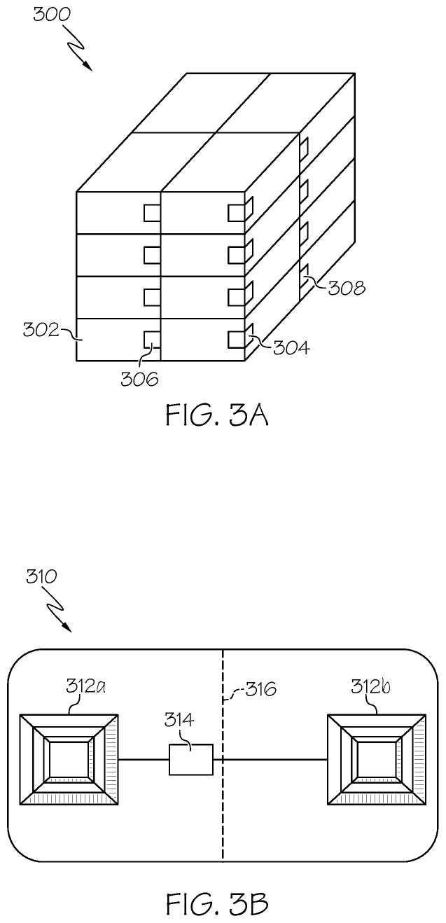

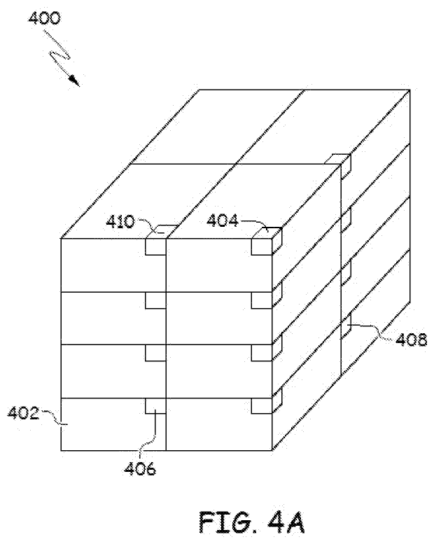

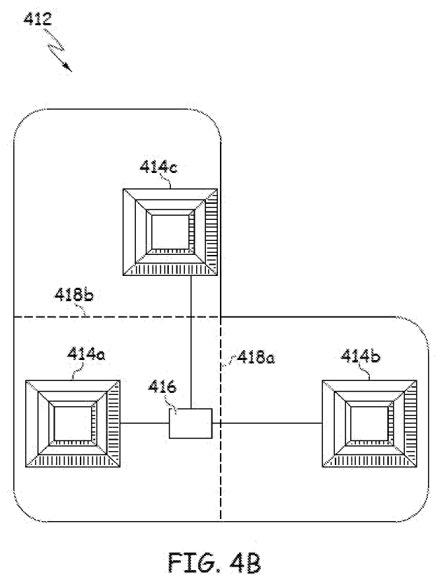

Referring now to FIG. 3A, several embodiments of forming and utilizing RFID labels may be shown and described. As described above, the application of at least one RFID label to a container such as cartons, which are then stacked and arranged on pallets, can cause problems due to the contents of the cartons blocking RF signals due to the placement of the RFID labels. This is reflected in FIGS. 1 and 2. However, as shown in FIGS. 3A and 4A, a at least one new RFID label 304, 404 may be placed on a perimeter portion such as an edge or corner of a carton 302, 402 that is arranged and stacked in a pallet configuration 300, 400.

In FIG. 3A, a plurality RFID labels 304 are shown as placed on edges or the perimeter of cartons 302. The RFID labels 304 have an RFID inlay 310 that can have a dual-element antenna 312a, 312b, as depicted in FIG. 3B. For example, an RFID label 304 may be formed by securing, for example by adhesive or the like, an RFID inlay 310 to a substrate. It is contemplated that the adhesive may be curtain coated, pattern coated or applied in any means known in the art. The substrate may define multiple portions of an RFID label 304 joined together at one or more fold lines; for example, the substrate may define a first portion 306 and a second portion 308 joined together at a fold line 316. Advantageously, in one embodiment, the RFID inlay 310 is secured to the substrate such that a first antenna element 312a is disposed within the first portion 306 and a second antenna element 312b is disposed within the second portion 308.

The dual-element antenna design may thus allow for RF signal capture on the RFID label 304 even if part of the RFID label 304 is blocked (e.g., the first portion 306 or the second portion 308). The RFID inlay 310 may be such that only a RFID chip 314 is utilized on the inlay 310, for example, substantially or partially substantially between the dual antenna elements 312a, 312b and proximate a fold line 316, which can provide for optimized utilization of a signal from either lobe of the dual-element antenna 312a, 312b. Such formation of an RFID inlay 310 for an RFID label 304 may further allow for improved placement of the RFID label 304 to provide better signal capture than traditional RFID labels, while also maintaining a low cost for manufacturing the RFID labels.

Still referring to FIG. 3A, when cartons or containers 302 are placed face to face or back to back, at least one portion of an RFID label 304 may be exposed. This can be shown in the following configurations, for example: fully exposed RFID label 304 disposed about an edge of a carton 302; exposed first portion 306 of an RFID label that is also disposed about an edge of a carton 302; and exposed second portion 308 of an RFID label that is also disposed about an edge of a carton 302. Thus it may be appreciated that RFID labels 304 are disposed about the perimeter or edge portions of cartons 302. This unique placement of RFID labels 304, specifically by placing a first portion 306 on one face of a carton and placing a second portion 308 on a second face of the carton, in conjunction with the dual-element antenna designs 312a, 312b of the RFID labels 304, allows for clear signal path to/from an RF reader or transponder to RFID labels 304 regardless of the contents of cartons 302 or properties of those contents (e.g. liquid, fabric, etc.).

One view of a dual-element antenna design RFID inlay 310 is shown in FIG. 3B. Here, the RFID inlay 310 includes a first antenna element 312a, a second antenna element 312b, and a RFID chip 314. It is also contemplated that the inlay 310 may include any number of antenna elements and is not limited to a first and second antenna element. RFID chip 314 may be disposed substantially or partially substantially between first antenna element 312a and the second antenna element 312b, connected electrically or communicatively to both the first and second antenna elements 312a, 312b, and proximate fold line 316 of RFID label 304. Fold line 316 may be such that it provides at least visual indicia for disposing an RFID label 304 about an edge of a carton, similar to the placement of labels shown in FIG. 3A. For example, fold line 316 may comprise one or more of a perforation, a score line, or a partial die-cut. Additionally, or alternatively, printed indicia may be included on a top face of the RFID label 304 along the fold line 316 to indicate the presence of the fold line 316. The printed indicia may be printed via any means contemplated in the art such as, but not limited to, digitally, ink jet, and/or laser.

A further embodiment of the present invention is depicted in FIGS. 4A and 4B. As shown in FIG. 4A, RFID labels 404 are shown as placed on corners of cartons 402. The RFID labels 404 have an RFID inlay 412 with a three-element antenna 414a, 414b, 414c, as depicted in FIG. 4B. The three-element antenna design may allow for RF signal capture on the RFID label 404 even if part of the RFID label 404 is blocked (e.g., one or more of the first portion 406, the second portion 408, or the third portion 410). The RFID inlay 412 may be such that only a RFID chip 416 is utilized on the inlay 412, for example, substantially between the three antenna elements 414a, 414b, 414c and proximate one or more fold lines 418a, 418b, which can provide for optimized utilization of a signal from any of the lobes of the three-element antenna 414a, 414b, 414c. Such formation of an RFID inlay 412 for an RFID label 404 may further allow for improved placement of the RFID label 404 to provide better signal capture than traditional RFID labels, while also maintaining a low cost for manufacturing the RFID labels.

Still referring to exemplary FIG. 4A, when cartons 402 are placed face to face or back to back, at least one portion of an RFID label 404 may be exposed. This can be shown in the following configurations, for example: fully exposed RFID label 404 disposed about corner of a carton 402; exposed first portion 406 of an RFID label that is also disposed about a corner of a carton 402; exposed second portion 408 of an RFID label that is also disposed about a corner of a carton 402; exposed third portion 410 of an RFID label that is also disposed about a corner of a carton 402; and any combination of two or more exposed portions 406, 408, 410 when RFID label 404 is disposed about a corner of carton 402. Thus it may be appreciated that RFID labels 404 are disposed about corners of cartons 402. This unique placement of RFID labels 404, specifically by placing a first portion 406 on one face of a carton, placing a second portion 408 on a second face of the carton, and placing a third portion 410 on a third face of the carton, in conjunction with the three-element antenna designs 414a, 414b, 414c of the RFID labels 404, allows for clear signal path to/from an RF reader or transponder to RFID labels 404 regardless of the contents of cartons 402 or properties of those contents (e.g. liquid, fabric, etc.).

An exemplary view of a three-element antenna design RFID inlay 412 is shown in exemplary FIG. 4B. Here, the RFID inlay 412 includes a first antenna element 414a, a second antenna element 414b, a third antenna element 414c, and a RFID chip 416. RFID chip 416 may be disposed substantially between the three antenna elements 414a, 414b, 414c, electrically connected to each of the three antenna elements 414a, 414b, 414c, and proximate one or more fold lines 418a, 418b. Fold lines 418a, 418b may be such that they provide at least visual indicia for disposing an RFID label 404 about a corner of a carton, similar to the placement of labels shown in FIG. 4A. For example, fold lines 418a, 418b may comprise one or more of a perforation, a score line, or a partial die-cut. Additionally, or alternatively, printed indicia may be included on a top face of the RFID label 404 along one or both of the fold lines 318a, 318b to indicate the presence of each fold line 318a, 318b.

As may be appreciated in exemplary FIGS. 3A-4B, even when cartons 302, 402 are placed in the face-to-face stacked configuration, at least one portion (e.g., first 306, 406, second 308, 408, or third 410) of RFID label 304, 404 is exposed to an outside perimeter of the pallet configuration 300, 400. Thus, RF signals from a reader or transponder (not illustrated) can reach each and every RFID label 304, 404 freely such that transmission of data can take place unencumbered. With the previous orientation of traditional RFID tags, as shown in FIG. 2, such transmission of data may not be possible or, at least, may be severely degraded.

As a result, it can be appreciated that RFID technology may be utilized in a variety of environments where it was not previously possible or desirable. For example, the exemplary embodiments described above can be utilized in highly challenging environments where the contents of cartons will typically prohibit proper and effective signal communications to and from traditional RFID labels. Thus, utilizing exemplary embodiments described herein, RFID labels may be utilized on stacks of cartons in such highly challenging environments and, further, such stacks may be provided in close proximity to each other, without any degradation or failure of transmission of RF signals between RFID labels and one or more RFID transponders.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A label comprising:
a substrate comprising a top face and a bottom face, the substrate defining a plurality of portions joined together at one or more fold lines; and
an RFID inlay disposed under the bottom face of the substrate, the RFID inlay comprising a multi-element antenna and an RFID chip located between and electrically connected to each element of the multi-element antenna.

2. The label of claim 1, where the plurality of portions comprises a first portion and a second portion.

3. The label of claim 2, where the first portion and the second portion are joined together at a first fold line.

4. The label of claim 3, where the plurality of portions further comprises a third portion.

5. The label of claim 4, where the first portion and the third portion are joined together at a second fold line.

6. The label of claim 2, where the multi-element antenna comprises a dual-element antenna such that a first antenna element is disposed adjacent to the bottom face of the substrate in the first portion and a second antenna element is disposed adjacent to the bottom face of the substrate in the second portion.

7. The label of claim 6, where the RFID chip is configured to be activated by one or both of the first antenna element and the second antenna element, and each of the first antenna element and the second antenna element is configured to send RF signals to and receive RF signals from an RFID reader.

8. The label of claim 4, where the multi-element antenna comprises a three-element antenna such that a first antenna element is disposed adjacent to the bottom face of the substrate in the first portion, a second antenna element is disposed adjacent to the bottom face of the substrate in the second portion, and a third antenna element is disposed adjacent to the bottom face of the substrate in the third portion.

9. The label of claim 8, where the RFID chip is configured to be activated by any one or more of the first antenna element, the second antenna element, and the third antenna element, and each of the first, second, and third antenna elements is configured to send RF signals to and receive RF signals from an RFID reader.

10. The label of claim 1, where the one or more fold lines comprise one or more of a perforation, a score line, or a partial die-cut.

11. The label of claim 1, further comprising printed indicia on the top face of the substrate to indicate the location of the one or more fold lines.

12. The label of claim 1, further comprising an adhesive and a removable backing.

13. A method of applying an RFID label to an item comprising:
securing a first portion of the RFID label having a first antenna element to a first area of the item; and
securing a second portion of the RFID label having a second antenna element to a second area of the item, where the first and second portions of the RFID label are joined together at a first fold line.

14. The method of claim 13, where the first area of the item is a first face of a carton, the second area of the item is a second face of the carton, and the first fold line is disposed along an edge that joins the first and second faces of the carton such that the first antenna element is secured to the first face of the carton and the second antenna element is secured to the second face of the carton.

15. The method of claim 14, further comprising aligning indicia printed on a top face of the RFID label along the first fold line with the edge that joins the first and second faces of the carton.

16. The method of claim 13, further comprising securing a third portion of the RFID label having a third antenna element to a third area of the item, where the third portion of the RFID label is joined to one of the first or second portions of the RFID label at a second fold line.

17. The method of claim 16, where the first area of the item is a first face of a carton, the second area of the item is a second face of the carton, the third area of the item is a third face of the carton, the first and second fold lines are disposed along different edges defined by the first, second, and third faces of the carton such that each of the first, second, and third antenna elements are secured to differing faces of the carton.

18. The method of claim 17, where the RFID label is secured to the carton at a corner of the carton.

19. The method of claim 13, further comprising removing a removable backing from the RFID label to expose an adhesive disposed along at least a portion of a bottom surface of the RFID label such that the first and second portions of the RFID label are secured to the item by the adhesive.

20. The method of claim 16, further comprising removing a removable backing from the RFID label to expose an adhesive disposed along at least a portion of a bottom surface of the RFID label such that the first, second, and third portions of the RFID label are secured to the item by the adhesive.
